(19) United States
(12) Patent Application Publication
(10) Pub. No.: US 2024/0323526 A1
(43) Pub. Date: Sep. 26, 2024

(54) IMAGING DEVICE, CONTROL METHOD OF IMAGING DEVICE AND RECORDING MEDIUM

(71) Applicant: CASIO COMPUTER CO., LTD., Tokyo (JP)

(72) Inventors: Katsuyuki MATSUO, Tokyo (JP); Kaisei IWATA, Tokyo (JP)

(73) Assignee: CASIO COMPUTER CO., LTD., Tokyo (JP)

(21) Appl. No.: 18/595,597

(22) Filed: Mar. 5, 2024

(30) Foreign Application Priority Data
Mar. 24, 2023 (JP) 2023-048672

(51) Int. Cl. H04N 23/67; H04N 23/56

(52) U.S. Cl. CPC H04N 23/671; H04N 23/56

(57) ABSTRACT

An imaging device includes an image sensor configured to photograph an imaging object, and a processor, the processor being configured to: derive a distance between the imaging object and the image sensor to obtain a derived distance; determine whether a close-up attachment is attached to the imaging device, based on the derived distance, to obtain a determination result; and set an imaging mode in accordance with the determination result.

### CROSS-REFERENCE TO RELATED APPLICATIONS

This application is based upon and claims the benefit of priority from prior Japanese Patent Application No. 2023-048672, filed Mar. 24, 2023, the entire contents of which are incorporated herein by reference.

### FIELD

The present disclosure relates to an imaging device, a control method of the imaging device and recording medium.

### BACKGROUND

In diagnosis of a skin disease, an imaging device called “dermoscopy camera”, which can photograph a pigmentary distribution or a hue of an inside of a skin, is utilized. For example, Jpn. Pat. Appln. KOKAI Publication No. 2016-214552 discloses a technology for performing photography by attaching a close-up attachment to a front surface of a commercially available camera, thereby to perform dermoscopy photography.

### SUMMARY

An imaging device according to the present disclosure includes an image sensor configured to photograph an imaging object, and a processor, the processor being configured to: derive a distance between the imaging object and the image sensor to obtain a derived distance; determine whether a close-up attachment is attached to the imaging device, based on a derived distance, to obtain a determination result; and set an imaging mode in accordance with the determination result.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate a embodiment of the invention, and together with the general description given above and the detailed description of the embodiment given below, serve to explain the principles of the invention.

FIG. 1 is a perspective view of a dermoscopy camera according to an embodiment of an imaging device of the present disclosure.

FIG. 2 is a perspective view of the dermoscopy camera, FIG. 2 illustrating a state in which a three-dimensional objects photographing adapter serving as a first close-up attachment is attached to the dermoscopy camera.

FIG. 3 is a perspective view of the dermoscopy camera, FIG. 3 illustrating a state in which a small diameter range photographing adapter serving as a second close-up attachment is attached to the dermoscopy camera.

FIG. 4 is an exploded perspective view of the dermoscopy camera.

FIG. 5 is a cross-sectional view of a lighting device provided in the dermoscopy camera.

FIG. 6 is a cross-sectional view of the lighting device to which the three-dimensional objects photographing adapter is attached.

FIG. 7 is a cross-sectional view of the lighting device to which the small diameter range photographing adapter is attached.

FIG. 8 is a block diagram illustrating an electrical configuration of the dermoscopy camera.

FIG. 9 is a flowchart for describing an example of a photography operation of the dermoscopy camera.

### DETAILED DESCRIPTION

Hereinafter, as an embodiment of an imaging device of the present disclosure, a dermoscopy camera is described by way of example by referring to the accompanying drawings. In the present specification, in accordance with the distinguished use of terms “Microscope: microscope” and “Microscopy: an examination by a microscope or a use (method) of a microscope”, the terms “Dermoscope” and “Dermoscopy” are used to mean a magnifier (device) for a dermatological examination, and a dermatological examination using the magnifier or a use (practice) of the magnifier.

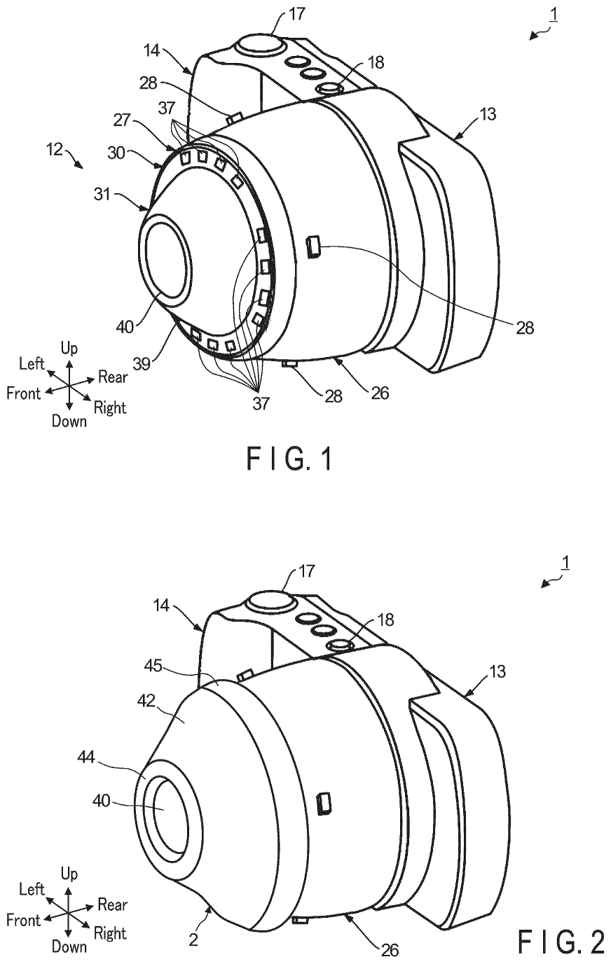

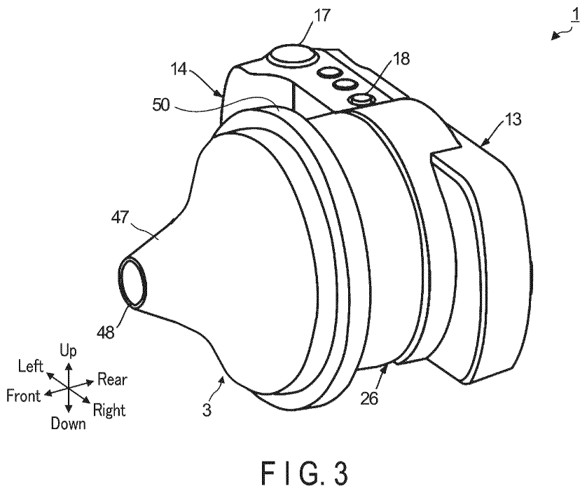

FIG. 1 is a perspective view of a dermoscopy camera 1 according to an embodiment of an imaging device of the present disclosure. In addition, FIG. 2 is a perspective view of the dermoscopy camera 1, FIG. 2 illustrating a state in which a three-dimensional objects photographing adapter 2 serving as a first close-up attachment is attached to the dermoscopy camera 1. FIG. 3 is a perspective view of the dermoscopy camera 1, FIG. 3 illustrating a state in which a small diameter range photographing adapter 3 serving as a second close-up attachment is attached to the dermoscopy camera 1. As illustrated in FIG. 1, the description below is given based on an orthogonal coordinate system in which an imaging object (subject) side is a front side (front surface, front face) of the dermoscopy camera 1, a side opposite thereto is a rear side, and upward, downward, left and right directions in a case where the dermoscopy camera 1 is viewed from the front side are upward, downward, left and right directions as such. In addition, unless otherwise mentioned, attachment relating to respective members is performed by an appropriate method, such as attachment with use of a screw, a vis, or the like, or attachment by engagement or the like.

The dermoscopy camera 1 is an imaging device that captures an image for examining a state of a skin. The dermoscopy camera 1 can photograph an imaging object both in a state in which the three-dimensional objects photographing adapter 2 or the small diameter range photographing adapter 3 is attached as illustrated in FIG. 2 or FIG. 3, and in a state in which the three-dimensional objects photographing adapter 2 and the small diameter range photographing adapter 3 are detached as illustrated in FIG. 1. The three-dimensional objects photographing adapter 2 is used in a case of performing close-up photography with a focus on the entirety of a skin affected part having a height. On the other hand, the small diameter range photographing adapter 3 is used in a case of photographing a narrow part such as a part between fingers, or a recess of an ear.

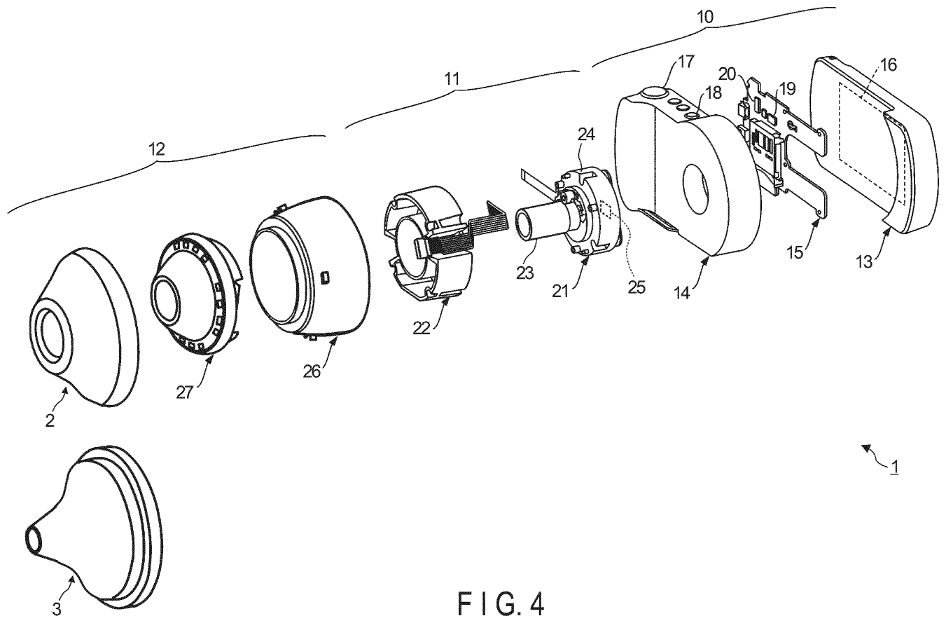

FIG. 4 is an exploded perspective view of the dermoscopy camera 1. As illustrated in FIG. 4, the dermoscopy camera 1 includes a controller 10, a camera body 11 provided in front of the controller 10, and a lighting device 12 provided in front of the camera body 11.

The controller 10 includes a display unit 13, a main body 14, and a circuit board 15 accommodated between the display unit 13 and the main body 14. The display unit 13 is provided with an LCD monitor 16 of a touch panel type, which displays various operation information and a photographed image, and accepts a user's operation. The main body 14 is provided with operation buttons such as a shutter button 17 and a power button 18. The circuit board 15 includes a memory unit 19 and a control unit 20. The memory unit 19 stores a photographed image and includes a ROM (Read Only Memory) and a RAM (Random Access Memory) functioning as at least one memory. The control unit 20 controls respective parts of the dermoscopy camera 1 and includes at least one processor.

The camera body 11 includes an imaging unit 21, and a frame 22 that is attached to a cover body 26 (to be described later) in a state of supporting the imaging unit 21. The imaging unit 21 includes an imaging lens system 23 including lenses provided on an optical axis OA. In addition, an image sensor 25 is accommodated in rear of the imaging lens system 23, i.e., on a rear side of a housing 24. The image sensor 25 is a publicly known image sensor, such as a CCD (Charge Coupled Device) image sensor or a CMOS (Complementary Metal Oxide Semiconductor) image sensor. The image sensor 25 is configured to convert an optical image of a subject into an electric signal. The imaging unit 21 can photograph an imaging object by using the image sensor 25. The imaging unit 21 can photograph, for example, a still image or a moving picture. Other detailed structures of the imaging unit 21 are described in detail in Japanese Patent No. 6897712. Thus, the description thereof is omitted in this specification.

The lighting device 12, as illustrated in FIG. 4, includes a cover body 26 attached to the main body 14 of the controller 10, a lighting device body 27 attached to a front end of the cover body 26, and the three-dimensional objects photographing adapter 2 and small diameter range photographing adapter 3, which are attached to the cover body 26 and cover a front side of the lighting device body 27. As described above, the three-dimensional objects photographing adapter 2 and small diameter range photographing adapter 3 are configured to be attachable and detachable. The sensors 2 and 3 are selectively attached to the cover body 26 in a case of photographing a three-dimensional object or a narrow part such as a part between fingers or a recess of an ear, while being detached in a case where a photographed part is a face, an arm or the like. In this manner, the three-dimensional objects photographing adapter 2 and small diameter range photographing adapter 3, if used for photography, constitute a part of the lighting device 12, and, if not used for photography, are not included in the lighting device 12.

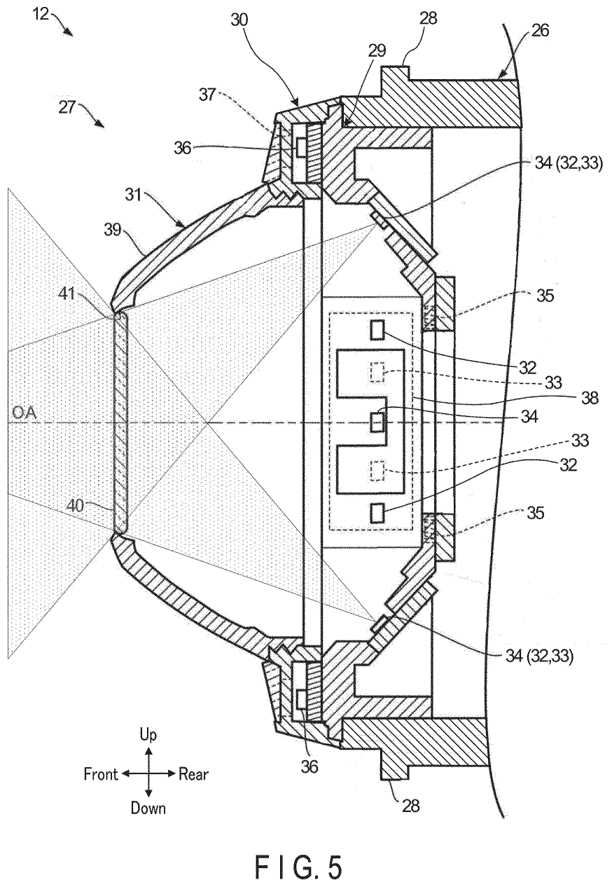

FIG. 5 is a cross-sectional view of the lighting device 12 provided in the dermoscopy camera 1. As illustrated in FIG. 1 to FIG. 5, the cover body 26 is formed in a cylindrical shape, and the camera body 11 is accommodated in the inside of the cover body 26. Four projection portions 28 are equidistantly disposed on an outer peripheral surface of the cover body 26. In a case of attaching the small diameter range photographing adapter 3, the projection portions 28 are engaged with the small diameter range photographing adapter 3. In a case of detaching the small diameter range photographing adapter 3, the engagement state between the projection portions 28 and the small diameter range photographing adapter 3 is released. Note that, like a lens cap (not illustrated) for lens protection, the three-dimensional objects photographing adapter 2 is attached in a state of being engaged with the outer peripheral surface of the cover body 26, and is not configured to be engaged with the projection portions 28.

The lighting device body 27, as illustrated in FIG. 5, includes a base part 29, a first cover part 30 and a second cover part 31. The base part 29 is provided with a plurality of LED boards on which LEDs (Light Emitting Diodes) functioning as light sources are amounted. The first cover part 30 has an annular shape and covering a periphery of the base part 29. The second cover part 31 screwed on the first cover part 30.

LEDs 32, 33 and 34 are attached to the base part 29 in four directions, namely upward, downward, left and right directions, around the optical axis OA. The LEDs 32 and 33 emit visible light, and the LEDs 34 emit ultraviolet. In each direction, five LEDs, namely the LED 32, LED 33, LED 34, LED 33 and LED 32, are disposed in a line in the named order. Of these LEDS, two LEDs 33 are covered by a polarizing plate 38. Thereby, the two LEDs 33 emit polarized light. The LEDs 32, 33 and 34 radiate light on a skin affected part, at a time of performing dermoscopy photography in a state of the lighting device 12 illustrated in FIG. 5 in which the three-dimensional objects photographing adapter 2 and the small diameter range photographing adapter 3 are detached, or at a time of performing three-dimensional objects photography with the three-dimensional objects photographing adapter 2 being attached.

In addition, four LEDs 35 are attached to the base part 29 around the optical axis OA. The four LEDs 35 emit visible light. The LEDs 35 radiate light on a skin affected part, in place of the LEDs 32, at a time of performing small diameter range photography with the small diameter range photographing adapter 3 being attached.

Furthermore, 16 LEDs 36 are attached to the base part 29 in an annular shape around the optical axis OA. The 16 LEDs 36 are, for example, LEDs that emit white light, and light emission holes 37 are formed in the first cover part 30 at positions corresponding to the LEDs 36. The light from the LEDs 36 is emitted from the circumferentially arranged light emission holes 37, and thereby the lighting device 12 can be caused to function as a ring flash that emits light in a forward direction from outer peripheral positions of the lighting device body 27. The LEDs 36 function as LEDs for clinical photography, which emit light and irradiate a skin affected part, at a time of photographing (clinical photography) the skin affected part by using the dermoscopy camera 1 as a general camera.

In this manner, the lighting device 12 is provided with the LEDs 36 that emit light at the time of performing clinical photography, the LEDs 32, 33 and 34 that emit light at the time of performing dermoscopy photography and three-dimensional objects photography, and the LEDs 35 that emit light at the time of performing small diameter range photography. Hereinafter, the LEDs 36 used at the time of performing clinical photography are referred to as “clinical photography LEDs”, the LEDs 32, 33 and 34 used at the time of performing dermoscopy photography and three-dimensional objects photography are referred to as “dermo-photography LEDs”, and the LEDs 35 used at the time of performing small diameter range photography are referred to as “small diameter range photography LEDs”.

The second cover part 31, as illustrated in FIG. 5, includes a cylinder 39 functioning as a first cover formed in a truncated conical cylinder shape, and a protective glass 40 fitted in an aperture 41 in a top portion (front end) of the cylinder 39. The protective glass 40 is formed of a light transmissive member, for example, glass, and is formed in a disc shape. The protective glass 40 is disposed such that a major surface thereof intersects at right angles with the optical axis OA, and the area of the major surface of the protective glass 40 is set to a predetermined first area. Light from the LEDs 32, 33 and 34 that are the dermo-photography LEDs and from the LEDs 35 that are the small diameter range photography LEDs is caused to pass through the protective glass 40 that is pressed on a skin affected part, and the light is radiated on the skin affected part. In addition, light reflected from the skin affected part is caused to enter the dermoscopy camera 1, and is guided to the imaging unit 21. By pressing the protective glass 40 on the skin, the distance between the skin and the dermoscopy camera 1 and the brightness of the illuminated skin can be kept constant, and a condition for exposure is stabilized, and thus the dermoscopy photography can stably be performed. Moreover, the protective glass 40 protects the inside of the dermoscopy camera 1 from moisture and dust.

Other detailed structures of the lighting device 12 are also described in detail in Japanese Patent No. 6897712. Thus, the description thereof is omitted in this specification.

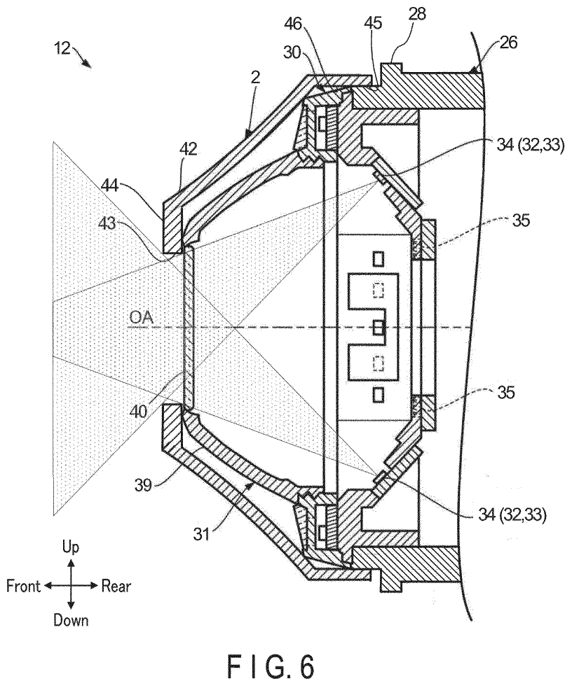

FIG. 6 is a cross-sectional view of the lighting device 12 to which the three-dimensional objects photographing adapter 2 is attached. As illustrated in FIG. 2 and FIG. 6, the three-dimensional objects photographing adapter 2 includes a cylinder 42 functioning as a second cover formed in a truncated conical cylinder shape, and an aperture 43 formed in a top portion (front end 44) of the cylinder 42. The cylinder 42 is formed of a resin, such as a polyvinylchloride derivative or an acrylic resin, and emboss processing or antireflection coating for suppressing light reflection is applied to the inner peripheral surface of the cylinder 42. In addition, as illustrated in FIG. 6, an engaging portion 45 is formed at a bottom part (rear end) of the cylinder 42. By an inner wall portion 46 of the engaging portion 45 being engaged with the outer peripheral portion of the cover body 26, the three-dimensional objects photographing adapter 2 can be attached to the cover body 26.

At a time of three-dimensional objects photography, a front surface of the front end 44 of the cylinder 42 is put in contact with a skin around the skin affected part that is the imaging object. In an inner peripheral part of a region where the skin is put in contact with the front surface of the front end 44, by the thickness of the front end 44 of the cylinder 42, a region is formed which is not in contact with the protective glass 40 formed at the top portion of the second cover part 31 of the lighting device 12. Thus, a skin affected part having a height, which is present in this region, does not come in contact with the protective glass 40. At the time of three-dimensional objects photography, the light emitted from the LEDs 32, 33 and 34 that are the dermo-photography LEDs is radiated on the skin affected part from the aperture 43 of the front end 44, and the light reflected by the skin affected part is let in. At the time of the three-dimensional object photography, by pressing the front surface of the front end 44 of the cylinder 42 on a skin around the skin affected part, the skin comes in contact with the front surface of the front end 44 in the region around the skin affected part, and thereby external light is blocked by the front end 44. Thereby, a skin in the region is less easily affected by external light, and the skin affected part entering the aperture 43 of the front end 44 is also less easily affected by external light.

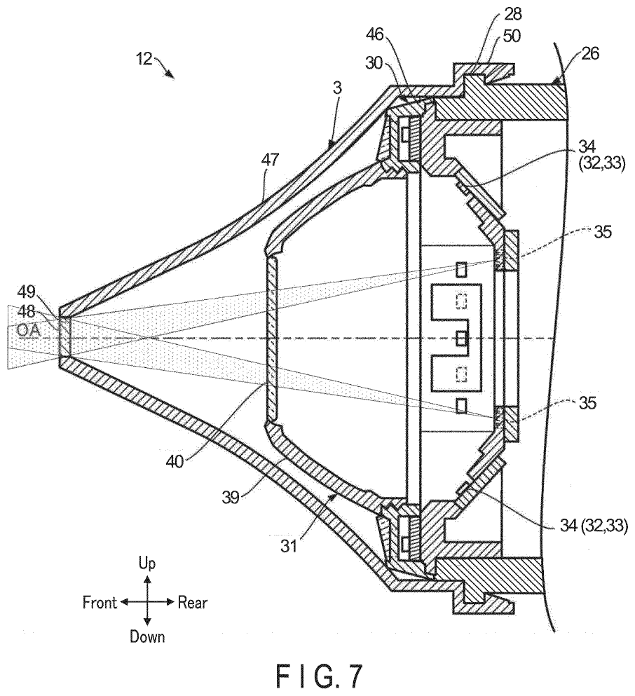

FIG. 7 is a cross-sectional view of the lighting device 12 to which the small diameter range photographing adapter 3 is attached. As illustrated in FIG. 3 and FIG. 7, the small diameter range photographing adapter 3 includes a cylinder 47 functioning as a second cover formed in a truncated conical shape, and a small diameter range photographing protective glass 48 fitted in an aperture 49 formed in a top portion (front end) of the cylinder 47. The cylinder 47 is formed of a resin, such as a polyvinylchloride derivative or an acrylic resin, and emboss processing or antireflection coating for suppressing light reflection is applied to the inner peripheral surface of the cylinder 47. In addition, as illustrated in FIG. 7, a hook portion 50 is formed at a bottom part (rear end) of the cylinder 47. By engaging the hook portion 50 with the projection portions 28 formed on the cover body 26, the small diameter range photographing adapter 3 can be attached to the cover body 26. On the other hand, in a case of detaching the small diameter range photographing adapter 3 from the cover body 26, the hook portion 50 is pushed outward to release the engagement with the projection portions 28. The hook portion 50 and projection portions 28 function to attach and detach the small diameter range photographing adapter 3 to and from the cover body 26.

The small diameter range photographing protective glass 48 is formed of a light transmissive member, for example, a glass body, and is formed in a disc shape. At a time of small diameter range photography, the small diameter range photographing protective glass 48 is put in contact with a skin affected part that is an imaging object. The small diameter range photographing protective glass 48 is disposed such that a major surface thereof intersects at right angles with the optical axis OA, and the area of the major surface of the small diameter range photographing protective glass 48 is set to a predetermined second area that is smaller than the first area of the protective glass 40. Thus, by the cylinder 47 with a tapered shape, the small diameter range photographing protective glass 48 can come in contact with a skin affected part at a narrow location. At a time of small diameter range photography, the small diameter range photographing protective glass 48 passes light emitted from the LEDs 35 that are the small diameter range photography LEDs, the light is radiated on the skin affected part, and light reflected by the skin affected part is let in.

At the time of small diameter range photography, a region where the skin is put in contact with a tip end of the cylinder 47 is formed around a region where the skin is put in contact with the small diameter range photographing protective glass 48. By the cylinder 47 that is put in contact with the skin in this region, external light is blocked, and the skin put in contact with the small diameter range photographing protective glass 48 is less easily affected by the external light. In addition, the advantageous effect that the small diameter range photography can stably be performed, which is obtained by the provision of the small diameter range photographing protective glass 48, is similar to the advantageous effect by the provision of the above-described protective glass 40.

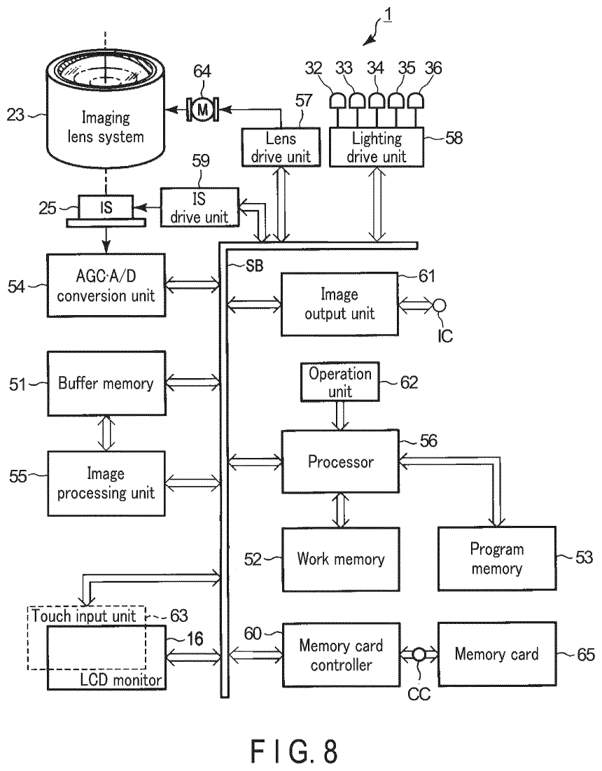

FIG. 8 is a block diagram illustrating an electrical configuration of the dermoscopy camera 1. The dermoscopy camera 1 includes, as the above-described memory unit 19, a buffer memory 51, a work memory 52 and a program memory 53. In addition, the dermoscopy camera 1 includes, as the above-described control unit 20, an AGC·A/D conversion unit 54, an image processing unit 55, a processor 56, a lens drive unit 57, a lighting drive unit 58, an image sensor drive unit 59, a memory card controller 60 and an image output unit 61.

In the dermoscopy camera 1, an optical image of a skin affected part that is an imaging object is made incident on an imaging surface of the image sensor 25 by the above-described imaging lens system 23, and the optical image is focused. Note that in FIG. 8, “image sensor” is indicated by “IS”.

In a monitor state called “through-image display” or “live view image display”, an image signal acquired by photography by the image sensor 25 is sent to the AGC·A/D conversion unit 54, and is digitized by executing correlated square sampling, automatic gain control, and A/D conversion processing. The resultant digital-value image data is stored in the buffer memory 51 via a system bus SB.

The image processing unit 55 applies a necessary image process, as appropriate, to the image data stored in the buffer memory 51. The image processing unit 55 applies a demosaicing process including a matrix operation, a pixel interpolation process, a gamma correction process and the like to the image data corresponding to a configuration of color filters of a Bayer arrangement included in the image sensor 25, thereby applying development to Bayer data that is raw data and converting the image data into image data of a luma-chroma (YUV) system. The image processing unit 55 creates, from the image data, image data in which the number of pixels and gradation bits are greatly reduced for display, sends the created image data to the LCD monitor 16, and causes the image data to be displayed as a through-image.

The processor 56, such as a CPU (Central Processing Unit), comprehensively controls the above-described circuits. The processor 56 is directly connected to the work memory 52 and the program memory 53. The work memory 52 is composed of, for example, a DRAM. The program memory 53 is composed of an electrically rewritable nonvolatile memory such as a flash memory, and fixedly stores operation programs including a photography operation control (to be described later), data, and the like. The processor 56 reads out a necessary program, data and the like from the program memory 53, temporarily develops and stores them in the work memory 52 as needed, and executes an overall control operation of the dermoscopy camera 1. Furthermore, the processor 56 executes a control operation in accordance with various key operation signals that are directly input from an operation unit 62 including operation buttons such as the above-described shutter button 17 and power button 18, and in accordance with operation signals from a touch input unit 63 provided on the above-described LCD monitor 16.

The touch input unit 63 is integrally formed on the LCD monitor 16 by using a transparent electrically conductive film, and sends coordinate information of a position, which is touch-operated by a user's finger, to the processor 56 as an operation signal.

The processor 56 is connected, via the system bus SB, to the above-described AGC·A/D conversion unit 54, buffer memory 51, image processing unit 55, LCD monitor 16 and touch input unit 63, and also to the lens drive unit 57, lighting drive unit 58, image sensor drive unit 59, memory card controller 60 and image output unit 61.

The lens drive unit 57 controls, upon receiving a control signal from the processor 56, the rotation of a DC motor (M) 64 for lenses, and moves the position of an imaging lens, among lenses constituting the imaging lens system 23, along the optical axis OA direction.

The lighting drive unit 58 drives the lighting of the LEDs 32, 33, 34, 35 and 36, upon receiving a control signal from the processor 56 at a time of image photography. Note that, as described above, although the dermoscopy camera 1 includes a plurality of LEDs 32, LEDs 33, LEDs 34, LEDs 35 and LEDs 36, FIG. 8 illustrates one LED 32, one LED 33, one LED 34, one LED 35, and one LED 36, for the sake of convenience of the drawing sheet.

The image sensor drive unit 59 executes a scan drive of the image sensor 25 in accordance with a photography condition or the like that is set at each time point.

The image processing unit 55 executes a demosaicing process on the image data that is sent from the AGC·A/D conversion unit 54 and stored in the buffer memory 51, at a time of image photography in accordance with the operation of the shutter button 17 of the operation unit 62. The image processing unit 55 further creates an image data file in which the data amount is greatly reduced by applying a data compression process of a predetermined data file format, for example, DCT (Discrete Cosine Transform) or Huffman coding if the data file format is JPEG (Joint Photographic Experts Group) format. The created image data file is recorded in a memory card 65 via the system bus SB and the memory card controller 60.

In addition, the image processing unit 55 receives, via the system bus SB, image data that is read out from the memory card 65 via the memory card controller 60 at a time of a playback mode, stores the image data in the buffer memory 51, and acquires image data of the original size by executing a decompression process of decompressing the image data stored in the buffer memory 51 by a reverse procedure to the procedure at the time of recording. Then, the image processing unit 55 outputs the image data to the LCD monitor 16 via the system bus SB, and causes the LCD monitor 16 to display the image data. Alternatively, the image processing unit 55 sends the image data to the image output unit 61 via the system bus SB, and outputs the image data from the image output unit 61 to the outside.

The memory card controller 60 is connected to the memory card 65 via a card connector CC. The memory card 65 is a recording memory for image data or the like, which is detachably attached to the dermoscopy camera 1 and functions as a recording medium of the dermoscopy camera 1. In the inside of the memory card 65, there are provided a flash memory, which is a nonvolatile memory that is electrically rewritable on a block-by-block basis, and a driving circuit of the flash memory.

The image output unit 61 transmits image data, which is sent from the image processing unit 55 at a time of playback mode, to an external monitor (not illustrated) via a cable (not illustrated) connected to an image output connector IC, and causes the external monitor to display the image data.

Next, a description is given of an operation of the dermoscopy camera 1 with the above-described configuration according to the embodiment of the imaging device of the present disclosure.

The dermoscopy camera 1 is started if the power button 18 is operated by the user. The photography modes of the dermoscopy camera 1 include a clinical photography mode of performing the above-described clinical photography, a dermoscopy photography mode of performing the dermoscopy photography, a three-dimensional objects photography mode of photographing a skin affected part having a height by utilizing the three-dimensional objects photographing adapter 2, and a small diameter range photography mode of photographing a narrow part, such as a part between fingers, or a recess of an ear, by utilizing the small diameter range photographing adapter 3.

A conventional dermoscopy camera, if started, first accepts a setting of a photography mode by a user. For example, the user selects one of the above-described photography modes by a touch operation on the LCD monitor 16, and, accordingly, the processor 56 sets the photography mode to the selected photography mode.

By contrast, since the dermoscopy camera 1 according to the present embodiment executes this setting of the photography mode, the setting operation of the photography mode by the user after the start is unnecessary.

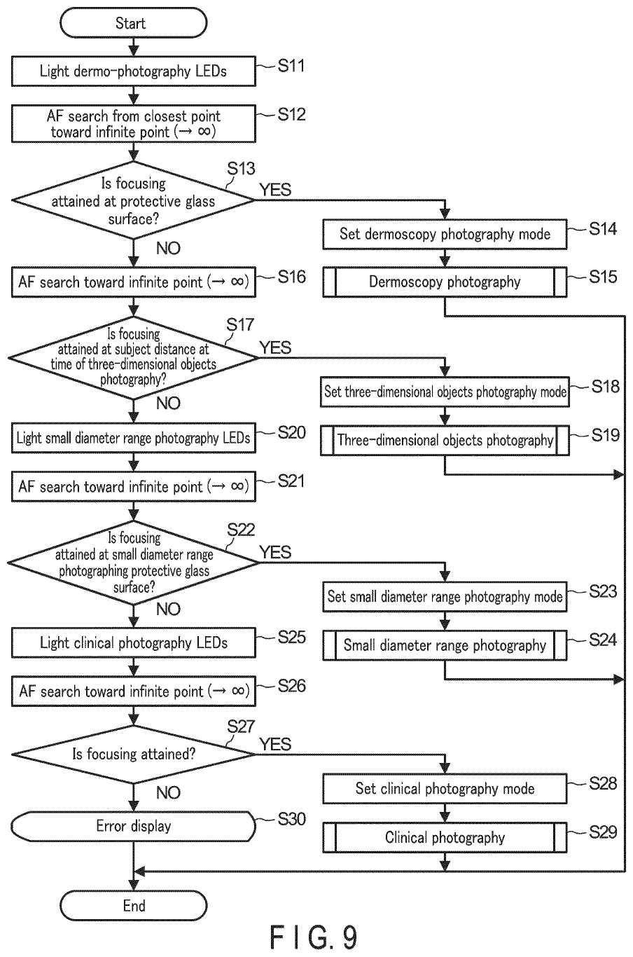

FIG. 9 is a flowchart for describing an example of a photography operation of the dermoscopy camera 1 according to the present embodiment. Note that since the playback operation of a photographed image is similar to conventional art, a description thereof is omitted. The photography operation illustrated in FIG. 9 is started in response to detection of a half press of the shutter button 17.

If the shutter button 17 is half-pressed by the user, the processor 56 lights the dermo-photography LEDs by the lighting drive unit 58 (step S11). Note that as regards the dermo-photography LEDs that are to be lighted, all of the LEDs 32, 33 and 34 may not be lighted. For example, only eight LEDs 32 that emit visible light may be lighted. In the case of performing close-up photography, as described above, external light is blocked since the front surface of the protective glass 40 or small diameter range photographing protective glass 48 is covered by the skin, and thus, in the absence of some illumination, an image acquired by the image sensor 25 becomes totally dark, and imaging by an auto-focus (AF) method (to be described later) cannot be performed. Thus, at first, the dermo-photography LEDs are lighted.

Next, the processor 56 executes an AF search from a closest point toward an infinite point (step S12). Specifically, while moving the imaging lens system 23 from the closest distance toward the infinite point by rotating the DC motor 64 for lenses by the lens drive unit 57, the processor 56 scan-drives the image sensor 25 by the image sensor drive unit 59 and acquires images, and searches for a focused point from the acquired images by a known AF method.

The processor 56 determines whether focusing is attained at a protective glass surface (step S13). Here, the protective glass surface is a front surface of the protective glass 40. Specifically, based on a focal distance at the time of the attainment of focusing, the processor 56 derives a distance between the skin affected part that is the imaging object and the image sensor 25 of the imaging unit 21, and determines whether the derived distance is a distance from the image sensor 25 to the protective glass surface. Note that the distance from the image sensor 25 to the protective glass surface can be derived from design values of the camera body 11, and the cover body 26 and lighting device body 27 of the lighting device 12, the design values being prestored in the program memory 53. Alternatively, a distance derived in advance, based on these design values, may be stored in the program memory 53. If the three-dimensional objects photographing adapter 2 or the small diameter range photographing adapter 3 is not attached and the skin is in direct contact with the protective glass surface, focusing is attained at the protective glass surface with which the skin is in contact. On the other hand, if the three-dimensional objects photographing adapter 2 or the small diameter range photographing adapter 3 is attached, or if close-up photography is not performed, focusing is not attained at the protective glass surface.

If the processor 56 determines that focusing is attained at the protective glass surface (step S13 (YES)), the processor 56 sets the photography mode to the dermoscopy photography mode (step S14).

Then, the processor 56 executes dermoscopy photography (step S15), and terminates this photography operation. Since the dermoscopy photography is similar to that in conventional art, a brief description thereof is given here. If the shutter button 17 is fully pressed, the processor 56 photographs the skin affected part while lighting the eight LEDs 32 that emit visible light, i.e., in a state in which the skin affected part that is in contact with the protective glass 40 is brightly irradiated with the visible light, and stores the photographed image in the memory card 65. Next, the processor 56 turns off the eight LEDs 32, lights eight LEDs 33 that emit visible light, and emits light polarized by the polarizing plate 38. Thereby, the skin affected part that is in contact with the protective glass 40 is brightly irradiated with the polarized light, and, in this state, the skin affected part is photographed and the photographed image is stored in the memory card 65. Next, the processor 56 turns off the eight LEDs 33, and lights four LEDs 34 that emit ultraviolet. Thereby, the skin affected part that is in contact with the protective glass 40 is brightly irradiated with the ultraviolet, and, in this state, the skin affected part is photographed and the photographed image is stored in the memory card 65. Then, the processor 56 turns off the four LEDs 34, and finishes the dermoscopy photography. In this manner, in the dermoscopy photography, by operating the shutter button 17 once, the skin affected part irradiated with the visible light, the skin affected part irradiated with the polarized light, and the skin affected part irradiated with ultraviolet are successively photographed, and the photographed images are recorded in the memory card 65.

In addition, if the processor 56 determines that focusing is not attained at the protective glass surface (step S13 (NO)), the processor 56 further continues the AF search toward the infinite point (step S16).

Then, the processor 56 determines that focusing is attained at the subject distance at the time of three-dimensional objects photography (step S17). Specifically, based on a focal distance at the time of the attainment of focusing, the processor 56 derives a distance between the skin affected part that is the imaging object and the image sensor 25 of the imaging unit 21, and determines whether the derived distance is within such a distance range as to be farther than the distance to the protective glass surface and nearer than the distance to the front surface of the front end 44 of the three-dimensional objects photographing adapter 2. This distance range can be derived from design values of the camera body 11, and the lighting device 12 in the case where the three-dimensional objects photographing adapter 2 is attached, the design values being prestored in the program memory 53. Alternatively, a distance range derived in advance, based on these design values, may be stored in the program memory 53. In the case where the three-dimensional objects photographing adapter 2 is attached, if the front surface of the front end 44 is pressed on the skin, the skin affected part having a height enters the aperture 43 formed in the front end 44, and focusing is attained at a top portion of the skin affected part having the height.

If the processor 56 determines that focusing is attained at the subject distance at the time of three-dimensional objects photography (step S17 (YES)), the processor 56 sets the photography mode to the three-dimensional objects photography mode (step S18).

Then, the processor 56 executes three-dimensional objects photography (step S19), and terminates this photography operation. Since the three-dimensional objects photography is similar to that in conventional art, a brief description thereof is given here. If the shutter button 17 is fully pressed, the processor 56 successively photographs, like the case of the dermoscopy photography, the skin affected part irradiated with the visible light, the skin affected part irradiated with the polarized light, and the skin affected part irradiated with ultraviolet, and records the photographed images in the memory card 65. Then, the processor 56 similarly performs dermoscopy photography by moving the imaging lens system 23 toward the infinite point side by only a fixed small distance. This is repeatedly performed up to the focal distance corresponding to the front surface of the front end 44 of the three-dimensional objects photographing adapter 2. Thus, in the three-dimensional objects photography, a plurality of images focused at various heights of the skin affected part having a height are acquired. By compositing these images, an image in which the entirety of the skin affected part having the height is focused can be acquired. This image compositing process is executed by the processor 56 or the image processing unit 55, and the image of the processing result can be recorded in the memory card 65. Needless to say, the image compositing process may be executed by some other external device.

In addition, if the processor 56 determines that focusing is not attained at the subject distance at the time of three-dimensional objects photography (step S17 (NO)), the processor 56 turns off the dermo-photography LEDs, and lights the four LEDs 35 that are the small diameter range photography LEDs and emit visible light (step S20). The four LEDs 35 are light sources that are arranged closer to the optical axis OA for the small diameter range photography. Thereby, the skin affected part that is in contact with the small diameter range photographing protective glass 48 is brightly irradiated with the visible light.

Then, the processor 56 continues the AF search toward the infinite point (step S21).

Thereafter, the processor 56 determines whether focusing is attained at a small diameter range photographing protective glass surface (step S22). Here, the small diameter range photographing protective glass surface is a front surface of the small diameter range photographing protective glass 48. Specifically, based on a focal distance at the time of the attainment of focusing, the processor 56 derives a distance between the skin affected part that is the imaging object and the image sensor 25 of the imaging unit 21, and determines whether the derived distance is a distance from the image sensor 25 to the small diameter range photographing protective glass surface. Note that the distance from the image sensor 25 to the small diameter range photographing protective glass surface can be derived from design values of the camera body 11, and the lighting device 12 to which the small diameter range photographing adapter 3 is attached, the design values being prestored in the program memory 53. Alternatively, a distance derived in advance, based on these design values, may be stored in the program memory 53.

If the processor 56 determines that focusing is attained at the small diameter range photographing protective glass surface (step S22 (YES)), the processor 56 sets the photography mode to the small diameter range photography mode (step S23).

Then, the processor 56 executes small diameter range photography (step S24), and terminates this photography operation. Since the small diameter range photography is similar to that in conventional art, a brief description thereof is given here. If the shutter button 17 is fully pressed, the processor 56 photographs the skin affected part while lighting the four LEDs 35 that emit the visible light, i.e., in the state in which the skin affected part in contact with the small diameter range photographing protective glass 48 is brightly irradiated with the visible light, and stores the photographed image in the memory card 65. Then, the processor 56 turns off the four LEDs 35, and terminates this small diameter range photography. In this manner, in the small diameter range photography, by operating the shutter button 17 once, the skin affected part irradiated with the visible light is photographed, and the photographed image is recorded in the memory card 65.

In addition, if the processor 56 determines that focusing is not attained at the small diameter range photographing protective glass surface (step S22 (NO)), the processor 56 turns off the small diameter range photography LEDs, and lights the 16 LEDs 36 that are the clinical photography LEDs and emit white light (step S25). Thereby, the skin affected part is brightly irradiated.

Then, the processor 56 continues the AF search toward the infinite point (step S26).

Thereafter, the processor 56 determines whether focusing is attained (step S27)

If the processor 56 determines that focusing is attained (step S27 (YES)), the processor 56 sets the photography mode to the clinical photography mode (step S28).

Then, the processor 56 executes clinical photography (step S29), and terminates this photography operation. Since the clinical photography itself is similar to photography by a general camera, a description thereof is omitted here. In the clinical photography, by operating the shutter button 17 once, the skin affected part irradiated with the white light is photographed, and the photographed image is recorded in the memory card 65.

If the processor 56 determines that focusing is not attained (step S27 (NO)), the processor 56 executes error display on the LCD monitor 16 (step S30). Then, the processor 56 terminates the photography operation.

As has been described above in detail, the dermoscopy camera 1 according to the present embodiment includes the imaging unit 21 that photographs a skin affected part that is an imaging object. The processor 56 derives a distance between the imaging object and the image sensor 25 of the imaging unit 21, determines, based on the derived distance, whether the three-dimensional objects photographing adapter 2 or the small diameter range photographing adapter 3, which is a close-up attachment, is attached to an own device, and sets a photography mode in accordance with a result of the determination. Thus, the photography mode can be set in accordance with the determination result of the state of attachment of the three-dimensional objects photographing adapter 2 or the small diameter range photographing adapter 3, which functions as the close-up attachment.

Note that the imaging unit 21 photographs the imaging object by an auto-focus method, and the processor 56 derives a distance between the imaging object and the image sensor 25 of the imaging unit 21, based on a focal distance at a time of photographing the imaging object. Thus, the distance between the imaging object and the image sensor 25 of the imaging unit 21 can easily be derived without adding a component such as a sensor.

Additionally, the dermoscopy camera 1 according to the present embodiment further includes the LEDs 32, 33, 34, 35 and 36 as at least one lighting unit that illuminates the imaging object, and the processor 56 lights some of the at least one lighting unit in a case of deriving the focal distance. Thus, even if the three-dimensional objects photographing adapter 2 or the small diameter range photographing adapter 3, which is the close-up attachment, is attached, it is possible to surely illuminate the skin affected part that is the imaging object, to acquire the image, and to derive the focal distance.

Additionally, the dermoscopy camera 1 according to the present embodiment controls, by the processor 56, the lighting state of the lighting unit in accordance with the photography mode that is set. Thus, with the illumination corresponding to the photography mode, the skin affected part that is the imaging object can be photographed.

Additionally, according to the dermoscopy camera 1 relating to the present embodiment, the lighting units include the LEDS 32, 33, 34 and 35 that are a first lighting unit (dermo-photography LEDs or small diameter range photography LEDs) illuminating a first range in regard to the imaging unit 21, and the LEDs 36 that are a second lighting unit (clinical photography LEDs) illuminating a second range different from the first range in regard to the imaging unit 21. The imaging modes include a dermoscopy photography mode, a three-dimensional objects photography mode and a small diameter range photography mode as a first imaging mode in which the first lighting unit is lighted, and a clinical photography mode as a second imaging mode in which the second lighting unit is lighted. Thus, without a labor of a user's manual operation, switching can be made between the close-up photography of the skin affected part that is the imaging object and the photography of the imaging object with the dermoscopy camera 1 being used as a general camera.

According to the dermoscopy camera 1 relating to the present embodiment, in the case of deriving the focal distance, the processor 56 lights the LEDs 32, 33, 34 and 35 that are the first lighting unit (dermo-photography LEDs or small diameter range photography LEDs), and, in the case where it is determined that the focal distance is the close-up distance, the processor 56 sets the first imaging mode and continues the lighting of the first lighting unit. In addition, in the case where the focal distance is not the close-up distance, the processor 56 switches the lighting of the first lighting unit to the lighting of the LEDs 36 that are the second lighting unit (clinical photography LEDs), and sets the second imaging mode. Thus, photography can be performed with the illumination corresponding to the photography mode.

Additionally, according to the dermoscopy camera 1 relating to the present embodiment, based on the derived distance, the processor 56 determines the kind of the close-up attachment, which is attached to the own device, and sets the photography mode in accordance with the determination result of the kind of the close-up attachment. Thus, since the photography mode can be switched in accordance with which of the close-up attachments is attached, even in the case where a plurality of close-up attachments are selectively used, the user can omit the labor of setting the photography mode suitable for the kind of the close-up attachment.

Note that according to the dermoscopy camera 1 relating to the present embodiment, the lighting units include the LEDs 32, 33 and 34 that are a first lighting unit (dermo-photography LEDs) illuminating a first range in regard to the imaging unit 21, and the LEDs 35 that are a second lighting unit (small diameter range photography LEDs) illuminating a second range different from the first range in regard to the imaging unit 21. The close-up attachments include the three-dimensional objects photographing adapter 2 functioning as a first close-up attachment, and the small diameter range photographing adapter 3 functioning as a second close-up attachment. In addition, the photography modes include a dermoscopy photography mode that is a first imaging mode using neither the three-dimensional objects photographing adapter 2 nor the small diameter range photographing adapter 3, a three-dimensional objects photography mode that is a second imaging mode using the three-dimensional objects photographing adapter 2, and a small diameter range photography mode that is a third imaging mode using the small diameter range photographing adapter 3. Thus, by only attaching the three-dimensional objects photographing adapter 2 or the small diameter range photographing adapter 3 to the dermoscopy camera 1, the user can photograph the skin affected part that is the imaging object in the photography mode corresponding to the adapter, without performing a mode selection operation.

Here, according to the dermoscopy camera 1 relating to the present embodiment, at the time of starting the deriving of the focal distance, the processor 56 lights the LEDs 32, 33 and 34 functioning as the first lighting unit (dermo-photography LEDs) and determines whether the three-dimensional objects photographing adapter 2 or the small diameter range photographing adapter 3 is attached to the own device. If the processor 56 determines that these are not attached, the processor 56 sets the dermoscopy photography mode that is the first imaging mode and continues the lighting of the LEDs 32, 33 and 34. In addition, if the processor 56 determines that the three-dimensional objects photographing adapter 2 is attached to the own device, the processor 56 sets the three-dimensional objects photography mode that is the second imaging mode, and continues the lighting of the LEDs 32, 33 and 34. Besides, if the processor 56 determines that the three-dimensional objects photographing adapter 2 is not attached to the own device, the processor 56 switches the lighting of the LEDs 32, 33 and 34 to the lighting of the LEDs 35 functioning as the second lighting unit (small diameter range photography LEDs), and continues the deriving of the focal distance. If the processor 56 determines that the small diameter range photographing adapter 3 is attached to the own device, the processor 56 sets the small diameter range photography mode that is the third imaging mode, and continues the lighting of the LEDs 35. Thus, the skin affected part that is the imaging object can be photographed by performing the illumination suited to the imaging mode corresponding to the kind of the close-up attachment that is attached.

Note that in the dermoscopy camera 1 according to the embodiment of the imaging device of the present disclosure, the distance between the skin affected part that is the imaging object and the image sensor 25 of the imaging unit 21 is derived based on the focal distance. However, needless to say, the distance between the skin affected part and the image sensor 25 may be derived by measuring the distance to the object by a distance sensor or the like.

Additionally, in the embodiment, the example was described in which two kinds of close-up attachments, namely the three-dimensional objects photographing adapter 2 and small diameter range photographing adapter 3, are selectively attached, but the number of kinds of close-up attachments is not limited to two. The present disclosure is also applicable to an imaging device adaptive to only one kind of close-up attachment, or to an imaging device adaptive to three or more kinds of close-up attachments including, for example, a microscope photographing adapter.

Additionally, in the embodiment, based on the distance between the imaging object and the image sensor 25 of the imaging unit 21, whether the close-up attachment is attached to the own device is determined, or the kind of the close-up attachment that is attached to the own device is determined. However, the processor 56 may determine whether a cover covering the imaging lens system 23 is attached to the own device, by deriving a focal distance by the auto-focus method or by deriving a distance by a distance sensor. If it is determined that the cover covering the imaging lens system 23 is attached to the own device, control may be executed to not light the LEDs 32 to 36. In other words, the imaging mode to be set can be a mode of prohibiting photography. In addition, the mode to be set may be not a mode relating to imaging, but an operation mode of executing control to not light the LEDs 32 to 36. Note that the cover covering the imaging lens system 23 may be not a cover coming in contact with the imaging lens system 23, but a cover covering the protective glass 40.

Additionally, in the embodiment, the processor 56 controls the operations of the respective circuit components in accordance with the instructions described in the program stored in the program memory 53, and the software and hardware cooperate to implement the photography functions. However, at least some of the photography functions may be implemented by an integrated circuit such as an ASIC (Application Specific Integrated Circuit), a DSP (Digital Signal Processor), an FPGA (field-programmable gate array) or a GPU (Graphics Processing Unit).

Furthermore, the flow of processes described with reference to the flowchart is not limited to the described order. The order of some steps may be changed, or some steps may be executed at the same time. Besides, the processing contents of some steps may be modified.

Additionally, in the embodiment, the dermoscopy camera 1 was described by way of example. However, needless to say, the present disclosure is also applicable to other imaging devices (close-up cameras), such as a colposcopy camera and a cervicoscopy camera, which photograph subjects by coming in contact with the subjects. Note that the colposcopy camera and cervicoscopy camera are imaging devices for examining the vagina and the cervix, and, like the dermoscopy, in accordance with the distinguished use of terms “Microscope: microscope” and “Microscopy: an examination by a microscope or a use (method) of a microscope”, the terms “Colposcope: vagina magnifier” and “Colposcopy: an examination by a vagina magnifier or a use (method) of a vagina magnifier”, and “Cervicoscope: side-viewing cervical endoscope” and “Cervicoscopy: an examination by a side-viewing cervical endoscope or a use (method) of a side-viewing cervical endoscope”, are used to mean magnifiers (magnifying devices) for examining the vagina and the cervix, and uterine cancer (cervical cancer) examinations using the magnifiers or uses (practices) of the magnifiers.

The methods of the processes by the dermoscopy camera 1 described in the above embodiment, that is, the methods such as the spreadsheet process illustrated in the flowchart of FIG. 9 and the spreadsheet software function conversion process illustrated in the flowchart of FIG. 8, can be distributed by being stored, as a computer-executable program, in a non-transitory recording medium of an external recording device, such as a memory card (ROM card, RAM card, or the like), a magnetic disk (floppy (trademark) disk, hard disk, or the like), an optical disc (CD-ROM, DVD, or the like), or a semiconductor memory. In addition, a control unit (processor 56) of an information processing apparatus (imaging device) reads the program recorded in the non-transitory recording medium of the external recording apparatus into a memory unit 19, and causes the operation to be controlled by the read program, thereby being able to implement the various functions described in the embodiment, and to execute processes similar to the processes by the above-described methods.

Additionally, the data of the program for implementing each method can be transmitted over a communication network as a mode of program code. The data of the program can be taken into the information processing apparatus (imaging device) from a computer apparatus (program server) connected to the communication network, and can be stored in the memory unit 19, and the above-described various functions can be implemented.

The present invention is not limited to the above-described embodiment. In practice, various modifications may be made without departing from the spirit of the invention. In addition, the embodiment may be implemented by being combined as appropriate, and advantageous effects of the combined embodiments can be obtained. Furthermore, the embodiment includes various, and various inventions can be derived from combinations selected from the structural elements disclosed herein.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An imaging device comprising an image sensor configured to photograph an imaging object, and a processor, the processor being configured to:
derive a distance between the imaging object and the image sensor to obtain a derived distance;
determine whether a close-up attachment is attached to the imaging device, based on the derived distance, to obtain a determination result; and
set an imaging mode in accordance with the determination result.

2. The imaging device of claim 1, wherein
the image sensor is configured to photograph the imaging object by an auto-focus method, and
the processor is configured to derive the distance, based on a focal distance at a time of photographing the imaging object.

3. The imaging device of claim 2, further comprising at least one lighting unit configured to illuminate the imaging object, wherein
the processor is configured to light some of the at least one lighting unit, in a case of deriving the focal distance.

4. The imaging device of claim 3, wherein the processor is configured to control a lighting state of the lighting unit in accordance with an imaging mode that is set.

5. The imaging device of claim 4, wherein
the lighting units include a first lighting unit illuminating a first range in an imaging range of the image sensor, and a second lighting unit illuminating a second range different from the first range in the imaging range of the image sensor, and
the processor is configured to set the imaging mode to one of a plurality of imaging modes, including a first imaging mode in which the first lighting unit is lighted and a second imaging mode in which the second lighting unit is lighted.

6. The imaging device of claim 5, wherein the processor is configured to:
light the first lighting unit at a time of deriving the focal distance;
set the imaging mode to the first imaging mode and continue lighting of the first lighting unit, in a case where the focal distance is determined to be a predetermined close-up distance; and
switch the lighting of the first lighting unit to lighting of the second lighting unit and set the imaging mode to the second imaging mode, in a case where the focal distance is determined to be not the predetermined close-up distance.

7. The imaging device of claim 4, wherein the processor is further configured to:
determine a kind of the close-up attachment that is attached to the imaging device, based on the derived distance; and
set the imaging mode in accordance with a determination result of the kind of the close-up attachment.

8. The imaging device of claim 7, wherein
the lighting units include a first lighting unit illuminating a first range in an imaging range of the image sensor, and a second lighting unit illuminating a second range different from the first range in the imaging range of the image sensor,
the close-up attachment attached to the imaging device includes at least one of a first close-up attachment and a second close-up attachment, and
the processor is configured to set the imaging mode to one of a plurality of imaging modes, including a first imaging mode in which neither first close-up attachment nor the second close-up attachment is used, a second imaging mode in which the first close-up attachment is used, and a third imaging mode in which the second close-up attachment is used.

9. The imaging device of claim 8, wherein the processor is configured to:
light the first lighting unit at a time of starting the deriving of the focal distance;
set the imaging mode to the first imaging mode and continue lighting of the first lighting unit, in a case where the focal distance is a predetermined first distance corresponding to the first imaging mode;
set the imaging mode to the second imaging mode, in a case where the focal distance is a predetermined second distance corresponding to the second imaging mode;
switch the lighting of the first lighting unit to lighting of the second lighting unit and continue the deriving of the focal distance, in a case where the focal distance is a predetermined third distance corresponding to the third imaging mode; and
set the imaging mode to the third imaging mode and continue the lighting of the second lighting unit, in a case where the second close-up attachment is determined to be attached to the imaging device.

10. A control method executed by a processor of an imaging device, the control method comprising:
by the processor, deriving a distance between an image sensor configured to photograph an imaging object and the imaging object to obtain a derived distance;
by the processor, determining whether a close-up attachment is attached to the imaging device, based on the derived distance, to obtain a determination result; and
by the processor, setting an imaging mode in accordance with the determination result.

11. A non-transitory computer readable recording medium storing a program for causing a processor of an imaging device, to:
derive a distance between the imaging object and the image sensor to obtain a derived distance;
determine whether a close-up attachment is attached to the imaging device, based on the derived distance, to obtain a determination result; and
set an imaging mode in accordance with the determination result.
